(19) United States
(12) Patent Application Publication
(10) Pub. No.: US 2026/0351104 A1
(43) Pub. Date: Nov. 5, 2026

(54) GUARDIAN DRONE SYSTEMS AND METHODS

(71) Applicant: Toyota Motor Engineering & Manufacturing North America, Inc., Plano, TX (US)

(72) Inventors: Danil V. Prokhorov, Canton, MI (US); Benjamin Piya Austin, Saline, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/194,336

(22) Filed: Apr. 30, 2025

(51) Int. Cl. G08B 21/02

(52) U.S. Cl. CPC G08B 21/02

(57) ABSTRACT

Systems and methods described herein relate to determining a set of real-time field of views, determining a threat location relative to the set of real-time field of views, generating a notification identifying the threat location relative to at least one real-time field of view, and announcing the notification. The announcing of the notification may include providing a threat location and a target location relative to the at least one real-time field of view. The announcing of the notification may also be provided via a directional alert message relative to the at least one real-time field of view.

### TECHNICAL FIELD

The subject matter described herein relates, in general, to strategies for providing increased situational awareness through guardian drones.

### BACKGROUND

When parents, teachers, etc. are walking children through traffic environments, such as along sidewalks or through intersections, they may act to protect their children from environmental dangers that may occur from nearby vehicles or other pedestrians. In more complex traffic environments, however, it may be difficult for such guardians to perceive and process a variety of environmental threats. Currently, guardians may rely on smart devices (e.g., phones, watches) to inform them of potential hazards, but such devices can visually distract guardians from observing the traffic environment.

### SUMMARY

In one embodiment, a drone management system is disclosed. The drone management system includes one or more processors and a memory communicably coupled to the one or more processors. The memory stores a command module including instructions that when executed by the one or more processors cause the one or more processors to determine a set of real-time field of views, determine a threat location relative to the set of real-time field of views, generate a notification identifying the threat location relative to at least one real-time field of view, and announce the notification.

In one embodiment, a non-transitory computer-readable medium including instructions that when executed by one or more processors cause the one or more processors to determine a set of real-time field of views, determine a threat location relative to the set of real-time field of views, generate a notification identifying the threat location relative to at least one real-time field of view, and announce the notification.

In one embodiment, a method is disclosed. In one embodiment, the method includes determining a set of real-time field of views, determining a threat location relative to the set of real-time field of views, generating a notification identifying the threat location relative to at least one real-time field of view, and announcing the notification.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a drone within which systems and methods disclosed herein may be implemented.

FIG. 2 illustrates one embodiment of a drone management system that is associated with providing increased situational awareness through guardian drones.

FIG. 3 illustrates one embodiment of a cloud computing environment within which the systems and methods described herein may operate.

FIG. 4 illustrates one example of a drone management system handling a guardian and wards at a crosswalk.

FIG. 5A illustrates one example of a drone management system using a flying drone component tethered to a backpack.

FIG. 5B illustrates one example of a drone management system using a flying drone component tethered to a water drone component.

FIG. 6 illustrates one example of a method for providing increased situational awareness through guardian drones.

### DETAILED DESCRIPTION

Systems, methods, and other embodiments are described herein associated with strategies for providing increased situational awareness through drones. Parents, schoolteachers, crossing guards, and others are often tasked with shepherding children through complex environments that may pose considerable safety risks. Such guardians may benefit from the assistance of a drone that can monitor the guardians, their wards, and the environment around them for threats. However, using a smartphone or tablet as an interface with a drone can be more harmful than helpful if it distracts the guardian or their wards from a threat.

Accordingly, an approach is described herein that may utilize the tracking of head movements to determine real-time field of views for guardians and wards. Based on these real-time field of views, the drone management system can announce threats relative to the perspective of a guardian or a ward, such as the direction to the threat or to the target of the threat, the location of the threat or target, the heading of the threat or target, etc. In addition, the drone management system can use visual, auditory, or haptic directional alert messages that convey a sense of direction via the senses of the recipient (e.g., being louder in the right ear vs the left ear).

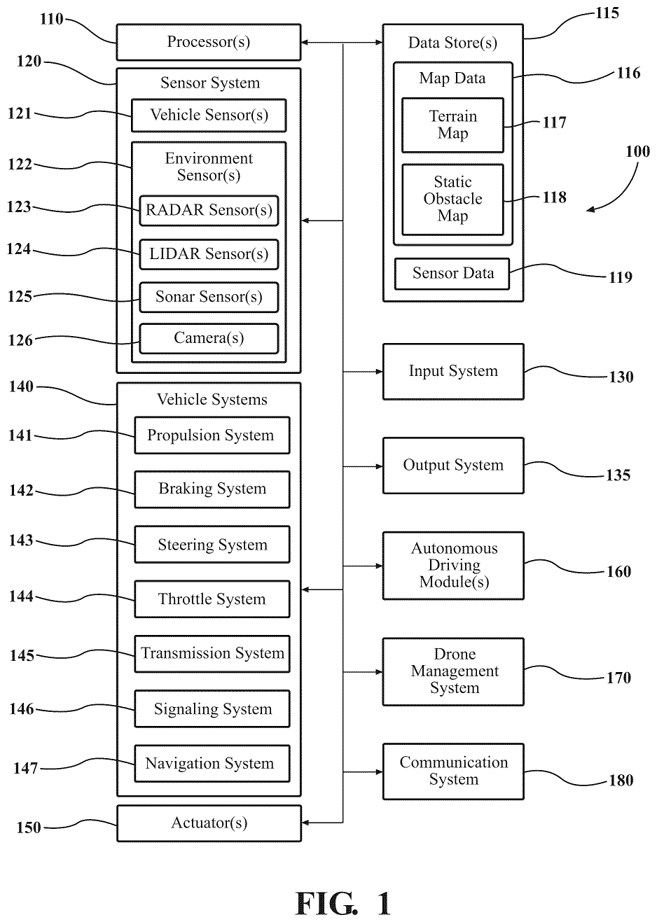

Referring to FIG. 1, an example of a drone 100 is illustrated. As used herein, a “drone” is any form of vehicle that operates without a human pilot, crew, or passengers onboard. In one or more implementations, drone 100 is an unmanned aerial vehicle (UAV). While arrangements will be described herein with respect to UAVs, it will be understood that embodiments are not limited to UAVs. In some implementations, drone 100 may be any robotic device that, for example, includes sensors to perceive aspects of the surrounding environment, and thus benefits from the functionality discussed herein. As a further note, drone 100 may be traveling in an environment (e.g., above or on a roadway) near surrounding vehicles, which may share information or functionality with drone 100 (e.g., via a cloud). That is, the surrounding vehicles may include any vehicle (e.g., another drone, cars) that may be encountered in an environment by drone 100.

Drone 100 also includes various elements. It will be understood that in various embodiments it may not be necessary for drone 100 to have all of the elements shown in FIG. 1. Drone 100 may have any combination of the various elements shown in FIG. 1. Further, drone 100 may have additional elements to those shown in FIG. 1. In some arrangements, drone 100 may be implemented without one or more of the elements shown in FIG. 1. While the various elements are shown as being located within drone 100 in FIG. 1, it will be understood that one or more of these elements may be located external to drone 100. Further, the elements shown may be physically separated by large distances. For example, as discussed, one or more components of the disclosed system may be implemented within a drone while further components of the system are implemented within a cloud-computing environment or other system that is remote from drone 100.

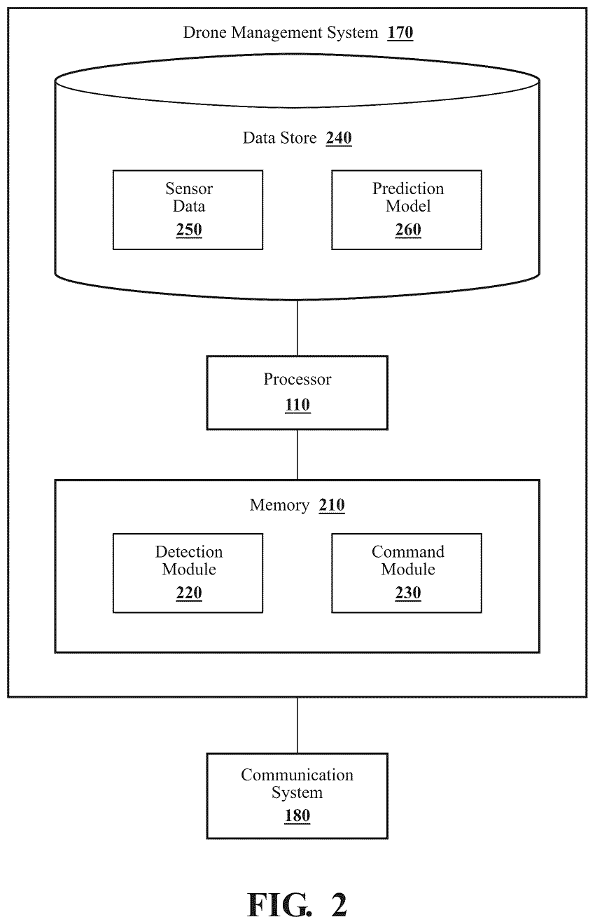

Some of the possible elements of drone 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, drone 100 includes a drone management system 170 that is implemented to perform methods and other functions as disclosed herein. As will be discussed in greater detail subsequently, drone management system 170, in various embodiments, is implemented partially within drone 100 and as a cloud-based service. For example, in one approach, functionality associated with at least one module of drone management system 170 is implemented within drone 100 while further functionality is implemented within a cloud-based computing system.

With reference to FIG. 2, one embodiment of drone management system 170 of FIG. 1 is further illustrated. Drone management system 170 is shown as including processors 110 from drone 100 of FIG. 1. Accordingly, processors 110 may be a part of drone management system 170, drone management system 170 may include a separate processor from processors 110 of drone 100, or drone management system 170 may access processors 110 through a data bus or another communication path. In one embodiment, drone management system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processors 110 cause processors 110 to perform the various functions disclosed herein.

Drone management system 170 as illustrated in FIG. 2 is generally an abstracted form of drone management system 170 as may be implemented between drone 100 and a cloud-computing environment. Accordingly, drone management system 170 may be embodied at least in part within a cloud-computing environment to perform the methods described herein.

With reference to FIG. 2, detection module 220 generally includes instructions that function to control processors 110 to receive data inputs from one or more sensors of drone 100. The inputs are, in one embodiment, observations of one or more objects in an environment proximate to drone 100, other aspects about the surroundings, or both. As provided for herein, detection module 220, in one embodiment, acquires sensor data 250 that includes at least camera images. In further arrangements, detection module 220 acquires sensor data 250 from further sensors such as radar 123, LiDAR 124, and other sensors as may be suitable for identifying vehicles, locations of the vehicles, lane markers, crosswalks, traffic signs, vehicle parking areas, road surface types, curbs, vehicle barriers, and so on.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within drone 100. Moreover, detection module 220 may undertake various approaches to fuse data from multiple sensors when providing sensor data 250, from sensor data acquired over a wireless communication link from one or more of the surrounding vehicles (e.g., drones, cars, trucks) or other sources (e.g., via V2V, V2I, V2X), or from a combination thereof. Thus, sensor data 250, in one embodiment, represents a combination of perceptions acquired from multiple sensors.

In addition to locations of surrounding vehicles, sensor data 250 may also include, for example, odometry information, GPS data, or other location data. Moreover, detection module 220, in one embodiment, controls the sensors to acquire sensor data about an area that encompasses 360 degrees about drone 100, which may then be stored in sensor data 250. In some embodiments, such area sensor data may be used to provide a comprehensive assessment of the surrounding environment around drone 100. Of course, in alternative embodiments, detection module 220 may acquire the sensor data about a forward direction alone when, for example, drone 100 is not equipped with further sensors to include additional regions about the vehicle or the additional regions are not scanned due to other reasons (e.g., unnecessary due to known current conditions).

Moreover, in one embodiment, drone management system 170 includes a database 240. Database 240 is, in one embodiment, an electronic data structure stored in memory 210 or another data store and that is configured with routines that may be executed by processors 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when separate sensor data 250 was generated, and so on.

Detection module 220, in one embodiment, is further configured to perform additional tasks beyond controlling the respective sensors to acquire and provide sensor data 250. For example, detection module 220 includes instructions that may cause processors 110 to obtain load characteristics as described herein. In some embodiments, detection module 220 may receive and store load characteristics.

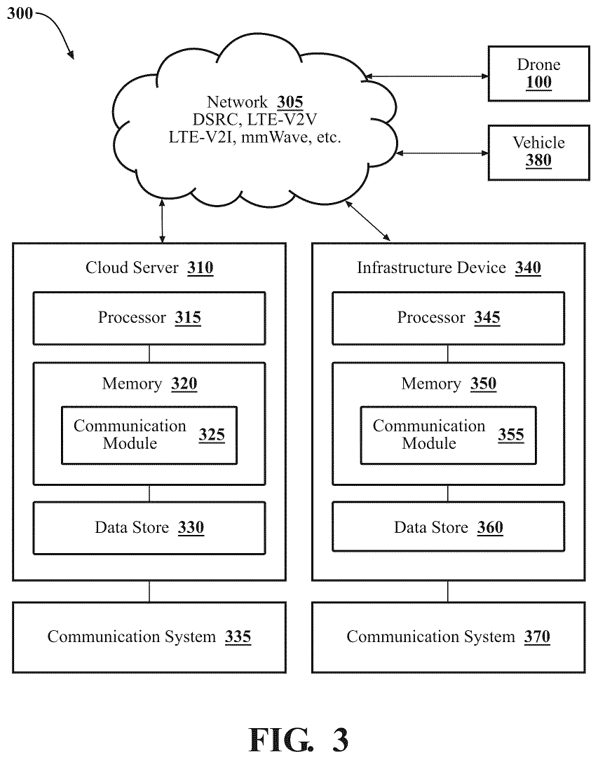

In one embodiment, command module 230 generally includes instructions that function to control the processors 110 or collection of processors in the cloud-computing environment 300 as shown in FIG. 3.

With reference to FIG. 3, drone 100 may be connected to a network 305, which allows for communication between drone 100 and cloud servers (e.g., cloud server 310), infrastructure devices (e.g., infrastructure device 340), other vehicles (e.g., vehicle 380), and any other systems connected to network 305. With respect to network 305, such a network may use any form of communication or networking to exchange data, including but not limited to the Internet, Directed Short Range Communication (DSRC) service, LTE, 5G, millimeter wave (mmWave) communications, and so on.

Cloud server 310 is shown as including a processor 315 that may be a part of drone management system 170 through network 305 via communication system 335 (e.g., a network router or bridge). In one embodiment, cloud server 310 includes a memory 320 that stores a communication module 325. Memory 320 is a random-access memory (RAM), read-only memory (ROM), a hard-disk drive, a flash memory, or other suitable memory for storing communication module 325. Communication module 325 is, for example, computer-readable instructions that when executed by processor 315 causes processor 315 to perform the various functions disclosed herein. Moreover, in one embodiment, cloud server 310 includes database 330. Database 330 is, in one embodiment, an electronic data structure stored in a memory 320 or another data store and that is configured with routines that may be executed by processor 315 for analyzing stored data, providing stored data, organizing stored data, and so on.

Infrastructure device 340 is shown as including a processor 345 that may be a part of drone management system 170 through network 305 via communication system 370 (e.g., a network router or bridge). In one embodiment, infrastructure device 340 includes a memory 350 that stores a communication module 355. Memory 350 is a random-access memory (RAM), read-only memory (ROM), a hard-disk drive, a flash memory, or other suitable memory for storing communication module 355. Communication module 355 is, for example, computer-readable instructions that when executed by processor 345 causes processor 345 to perform the various functions disclosed herein. Moreover, in one embodiment, infrastructure device 340 includes a database 360. Database 360 is, in one embodiment, an electronic data structure stored in memory 350 or another data store and that is configured with routines that may be executed by processor 345 for analyzing stored data, providing stored data, organizing stored data, and so on.

Accordingly, in addition to information obtained from sensor data 250, drone management system 170 may obtain information from cloud servers (e.g., cloud server 310), infrastructure devices (e.g., infrastructure device 340), other vehicles (e.g., vehicle 380), and any other systems connected to network 305. For example, cloud servers (e.g., cloud server 310) may be used to perform the same tasks as described herein with respect to command module 230.

In some embodiments, command module 230 may be assigned to a guardian. In examples that follow, a guardian may be a parent, teacher, or other individual who could benefit from enhanced awareness that may be provided by a guardian drone, especially when charged with the responsibility of providing care for others (e.g., children or elderly that are walking with the guardian). In some embodiments, the system may also be advantageous for guardian animals (e.g., dogs trained to assist the blind). However, a guardian may also be any person or animal that may benefit from the systems and methods described herein, regardless of whether such a person or animal has a responsibility or training to protect others.

In some embodiments, the guardian may be assigned by a user of drone management system 170 via command module 230. For example, a user may have an app that allows the entry of a username and password to access user settings of drone management system 170. Upon access to the user settings, guardian roles may be assigned to the user, to other people, to other animals, the bearer of a wearable or portable device, etc. In some embodiments, assigning a guardian role may prompt drone management system 170 to use biometric techniques to uniquely identify a person or animal with a guardian assignment. For example, a guardian assignment may be based on facial or fingerprint recognition. As another example, a guardian assignment may be based on whoever drone management system 170 recognizes as bearer of a wearable or portable device assigned to provide guardian drone service. For example, drone management system 170 may recognize the bearer of a smartphone as a guardian until such time they put down or hand off the smartphone. As another example, a service animal bearing a smart collar assigned to provide guardian drone service may be recognized by drone management system 170 as a guardian.

In some embodiments, a guardian may also be associated with one or more wards. For example, a ward may be a child, an elderly person, a disabled person, or any other person or animal that a guardian may establish as a ward. A ward may be associated with a guardian through the user settings within drone management system 170. In some embodiments, a guardian may designate a ward or remove such designation through verbal or visual instructions received by command module 230. For example, command module 230 may receive a verbal instruction from a guardian to add a ward (e.g., add Michael). As another example, command module 230 may designate wards based on bearers of portable or wearable devices, indicators, or context. For example, children wearing a specific color wristband may be determined to be wards of a guardian. As another example, a person carrying a smartphone may be designated a ward (e.g., of a service dog guardian). As yet another example, any child within 100 feet of a guardian may be designated a ward.

In some embodiments, command module 230 may control drone 100 to provide guardian protection services via drone management system 170 as described herein for a guardian, any ward associated with a guardian, or both. Drone 100 may take the form of a flying drone, ground drone, a water drone, other autonomous devices, etc. In some embodiments, drone 100 may take the form of an ensemble of drones operated by command module 230 (e.g., a flying drone tethered to a ground or water drone).

In some embodiments, command module 230 may generate a coverage map for drone 100 relative to a guardian in which drone 100 is to search to threats to the guardian. For example, command module 230 may determine a coverage map based on factors such as the actual or potential speed of the guardian, weather, the actual or potential speed of expected threats, the nature of expected threats (e.g., animals, vehicles, cyclists, pedestrians), traffic density (e.g., vehicle, pedestrian), lane markings, barriers (e.g., fences, hedges), the location and distance of any wards relative to the guardian, etc.

In some embodiments, command module 230 may utilize information obtained from other sources besides drone 100 to generate or enhance a coverage map via sensor data 250. For example, other vehicles or infrastructure devices may communicate their own sensor data (e.g., images, sounds, radar, structural models of objects) allowing a coverage map to be evaluated in terms of more than two-dimensions. In this manner, if drone 100 is an overhead flying drone relative to a guardian, then a coverage map initially generated from an aerial perspective may be further adjusted to include height data or other information regarding objects within the coverage map (e.g., the height of fences, gaps in the fence), which may not be sufficiently observed by the sensors of drone 100. In some embodiments, command module 230 may also utilize information obtained from other sources besides drone 100 to track guardians or wards via sensor data 250. For example, if a vehicle passes between the line of sight between drone 100 and a guardian or ward, sensor data 250 may nonetheless contain sufficient information via other vehicles or devices for command module 230 to continue tracking the location of the guardian or the ward.

In some embodiments, command module 230 may generate the coverage maps by assessing the likelihood of threats and the potential harm of such threats to a guardian, any wards, or both. Such an assessment may be based on the factors described above in terms of generating a coverage map by command module 230. In some embodiments, command module 230 may apply threshold requirements based on the likelihood of threats, the potential harm of such threats, the available time to avoid potential threats (e.g., time to collision), other measures of threats, or a combination thereof to determine the edges of a coverage map.

In some embodiments, command module 230 may determine a coverage plan for drone 100. For example, command module 230 may use a pre-determined function to determine a relative position to a guardian that drone 100 should maintain (e.g., stay 6 feet ahead of and 12 feet above the guardian). Such a pre-determined function may incorporate factors such as the actual or potential speed of the guardian, weather, the actual or potential speed of expected threats, the nature of expected threats (e.g., animals, vehicles, cyclists, pedestrians), traffic density (e.g., vehicle, pedestrian), lane markings, barriers (e.g., fences, hedges), the location and distance of any wards relative to the guardian, etc. As another example, command module 230 may use a survey algorithm to determine an optimal scanning pattern for drone 100 within the coverage map, which may also incorporate factors such as the actual or potential speed of the guardian, weather, the actual or potential speed of expected threats, the nature of expected threats (e.g., animals, vehicles, cyclists, pedestrians), traffic density (e.g., vehicle, pedestrian), lane markings, barriers (e.g., fences, hedges), the location and distance of any wards relative to the guardian, etc. Such a survey algorithm may be optimized to scan more frequently in areas having higher measures of threat (e.g., in terms of speed, potential harm, TTC), in full or partial blind spots relative to the guardian or any wards, in areas having higher traffic density, other relevant factors, or a combination thereof.

In some embodiments, command module 230 may take into account impairment/sensitivity data regarding any guardian or ward when generating a coverage map or coverage plan. For example, if a guardian or ward is visually impaired command module 230 may adjust a survey algorithm based on the restricted field of view of such a guardian or ward. As another example, if the guardian or ward is physically impaired (e.g., on crutches), command module may adjust factors relied on to determine a coverage map or coverage plan (e.g., placing a constraint on the potential speed of the guardian or ward when generating a coverage map or coverage plan).

In some embodiments, command module 230 may determine field of view (FOV) data for a guardian or a ward, such as by use of a pre-defined model or algorithm for determining FOV. For example, a human being typically has a combined binocular FOV spanning around 180 degrees horizontally and 150 degrees vertically. An individual human eye typically has an FOV of 130 degrees horizontally. In addition, objects being worn (e.g., hat, glasses, eye patch, helmet, AR/VR devices) or medical health (e.g., full or partial blindness, glaucoma, macular degeneration, stroke) may affect a FOV for a guardian or ward. Accordingly, command module 230 in determining an FOV may take into account animal type (e.g., human, dog, horse, cat), age (child, young, adult, elderly), worn objects, medical health, VR/AR modifiers, or other factors. With respect to VR/AR modifiers, the FOV presented to a guardian or ward may depend on the focal length, sensor size, aspect ratio, or other settings/specifications of the AR/VR device that affect the visual perception of information seen by a guardian or ward when wearing the AR/VR device. For example, a person wearing VR device may have a narrow or expanded field of view depending on how video is captured by the VR device and presented to the wearer. As another example, AR devices may provide additional FOV data (e.g., side view, rear view) that may impair natural FOV (e.g., such data if placed at the bottom of eyeglasses may be worthwhile for a wearer but nonetheless impair views of the ground). In some embodiments, command module 230 in determining an FOV may also take into account factors such as lighting conditions, weather elements like rain or fog, physical obstructions like trees or walls, dust or smoke in the air, ambient temperature, humidity, refractive indexes (e.g., water vs. air), etc. For example, a swimmer may be determined by command module 230 to have a FOV restricted to above the surface of a lake if swimming on the water and an FOV restricted to below the surface of a lake if swimming underwater. In some embodiments, command module 230 may adjust FOV data for a guardian or ward, such as where command module 230 evaluates guardian or ward behavior in view of objects that do not sufficiently cause an expected reaction (e.g., ducking to avoid nearby umbrellas) for an estimated FOV.

In some embodiments, command module 230 may track the head movement of a guardian or ward to determine a real-time FOV for a guardian or ward. For example, command module 230 may utilize face tracking, landmark tracking, or other visual algorithms to determine a real-time FOV (e.g., where the FOV for a guardian or ward is centered based on head position). In some embodiments, command module 230 may receive visual data of a guardian or ward from drone 100, other vehicles, other devices (e.g., any non-vehicular system such as a smart phone, tablet, infrastructure device), etc. such that command module 230 may determine a real-time FOV for a guardian or ward based on such visual data. that. In some embodiments, a wearable device may indicate the position, orientation, or both of the head of a guardian or ward (e.g., via accelerometers, gyroscopes, magnetometers, and camera sensors of a VR/AR device), such that command module 230 may determine a real-time FOV for a guardian or ward. In some embodiments, a real-time FOV may be divided into multiple regions (e.g., primary FOV, peripheral FOV). In some embodiments, the systems and methods herein may be applied to the full range of a real-time FOV or alternatively a particular range within the real-time FOV (e.g., primary FOV, 130 degrees).

In some embodiments, command module 230 may determine that a threat notification should be generated for a guardian or a ward. For example, command module 230 may determine that a hazard or object exists that is a threat or guardian based on a threat identification algorithm. For example, drone 100 may track moving objects and determine if a collision is likely to occur with a guardian or ward, which if such likelihood is above a threshold may cause a threat notification to be generated. As another example, drone 100 may track hazards that a guardian or a ward may be approaching (e.g., a pothole, slippery pavement, flooded areas, biohazards, dangerous animals) and determine if an encounter with the hazard is likely to occur, which if such likelihood is above a threshold may cause a threat notification to be generated.

In some embodiments, when a threat notification is generated, command module 230 may determine where the threat or hazard is relative to the real-time FOV of a guardian or ward. For example, if a ward is staring at his or her feet and about to walk into a person, command module 230 may determine that the person-based threat is above the ward's real-time FOV. As another example, if a guardian is walking next to shrubbery on his right and a dog is about to attack through the shrubbery, command module 230 may determine that the dog-based threat is to the right of the guardian's real-time FOV.

In some embodiments, command module 230 may announce a threat notification. For example, command module 230 may announce by audio, visual, or haptic devices a threat notification, which may include presenting information indicating one or more characteristics of the threat or hazard, whom will be affected (e.g., guardian, ward(s), or both), the relative location of the threat or hazard to the real-time FOV of a guardian or ward, and so on. For example, drone 100 may announce though speakers the target(s) of a threat, the nature of the threat, and how it would be perceived by a guardian, ward(s), or both based on real-time FOVs (e.g., “Watch out Alice, there's a dog coming at you from your right!”, “Nancy, Alex to your right is about to step into a pothole.” “Hey lifeguard, blow the whistle, a kid is swimming in the pool lanes below you”). In some embodiments, command module 230 may utilize directional audio (e.g., via ultrasonic speakers on drone 100, left and right speakers of a wearable device) to further enhance an audio announcement by adjusting the sound distribution relative to a real-time FOV of a guardian or ward. For example, an audio announcement presenting a danger to the right of a guardian's real-time FOV may be louder on the right side of the guardian's head than on the left side. In some embodiments, command module 230 may adjust the pitch, intensity, or other characteristics of the announcement in relation to the likelihood of danger to a guardian or ward. In some embodiments, command module 230 may reflect audio against an object, structure, surface, etc. when performing an audio announcement (e.g., an audio announcement reflected against a house may proclaim, “There's a dog over here!”).

In some embodiments, drone 100 may announce though lights or other visual devices the target(s) of a threat, the nature of the threat, and how it would be perceived by a guardian, ward(s), or both based on real-time FOVs. For example, drone 100 may use a strobe light to indicate to a hearing-impaired guardian the presence of a threat, followed by a projected image that may be presented within and then follows the guardian's real-time FOV. In such an embodiment, text or symbols of the projected image along with where the image is presented in the real-time FOV may indicate directionality of the threat (e.g., an image presented to the right lower side of a guardian's FOV showing a ward being chased by a dog from the right may indicate that: (a) the ward is to the right of the guardian; and (b) a dog is coming to the right of the child).

In some embodiments, wearable or portable devices may also be used to present audio or video announcements as described above via command module 230. In addition, command module 230 may use haptics to announce a threat notification. For example, a guardian in the form of service animal may be assisting a ward in the form of a visually impaired individual. The guardian may be trained to respond to haptic messages presented by a smart collar, smart harness, etc. For example, a haptic announcement may indicate to the guardian via training whether to halt, move to the left, move to the right, or to perform other actions in addition to another other training that the guardian has received. Moreover, visual/audio/haptic announcements may also be used based on training of a service animal to indicate the relative direction of a threat to the guardian (e.g., a tone played on the right side of the ear indicates to the service animal should look right). In some embodiments, command module 230 may utilize directional haptics (e.g., increased intensity in the direction of the threat). As such, directional alert messages based on audio, visual, or haptic components may be generated by command module 230 to indicate a sense of directionality (e.g., the direction of a threat, the direction of a guardian or ward) to a guardian or ward relative to his or her real-time FOV.

In some embodiments, command module 230 may have notification settings indicating when directional information may be provided based on real-time FOV. For example, directional information may be optional when a threat is within the real-time FOV of the recipient of a threat notification, but mandatory when it is outside the real-time FOV. As another example, notification settings may indicate when directional information about a guardian or ward should be provided. For example, if a ward under threat is outside the real-time FOV of a guardian, the notification setting may provide that directional information be provided in a threat notification to the guardian. Similarly, if a guardian is outside the real-time FOV of a ward, the notification setting may provide that directional information be provided in a threat notification to the ward (e.g., get back to your dad, he's right behind you!”).

In some embodiments, command module 230 may determine that a tracker notification should be generated for a guardian or a ward. A tracker notification may be used to aid a guardian or ward in locating anything of interest within a coverage map. For example, ward settings may define one or more conditions that a ward must satisfy, such as proximity to a guardian, proximity to other wards, maximum speed of the ward, allowed or prohibited activities, etc. Accordingly, command module 230 may track wards and determine if a condition within the ward settings requires a tracker notification to be generated. A tracker notification may then be announced using the same systems and methods described herein. For example, command module 230 may instruct drone 100, a smart device, a smart collar, etc. to provide visual, audio, or haptic messages allowing a guardian or ward to find each other, where such messages may include directional information, reason for the tracker notification, etc. In some embodiments, a tracker notification may also be used because a guardian or ward has instructed command module 230 to locate a thing of interest (e.g., a car, a store). For example, a guardian or a ward may verbally instruct drone 100 to help them locate the family cat who has escaped outside.

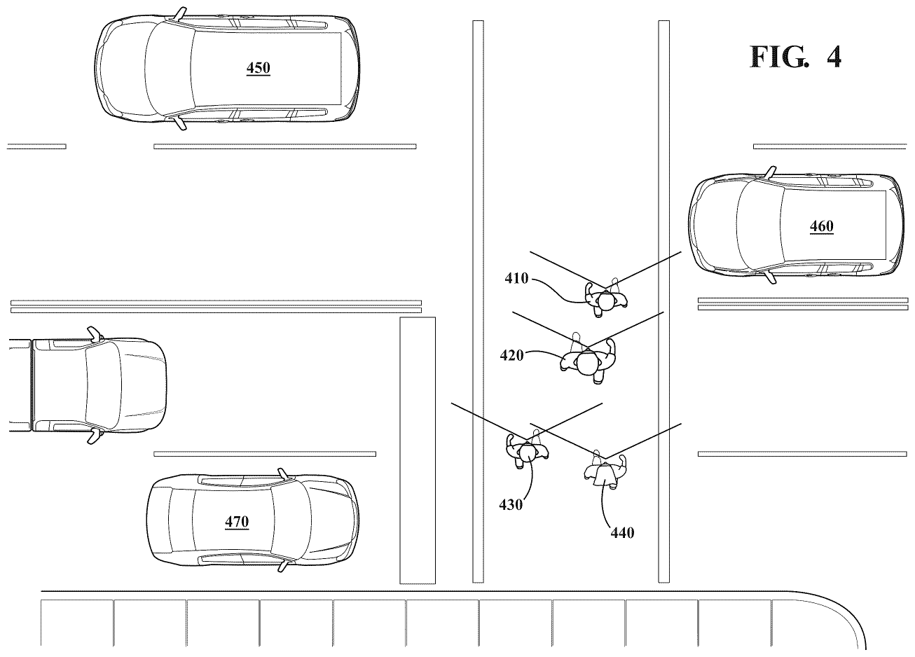

FIG. 4 illustrates an example of an environment in which drone management system 170 may be help a crosswalk monitor aid children crossing an intersection. In such an example, the crosswalk monitor may be recognized as a guardian and any child within the coverage map generated by command module 230 may be recognized automatically as a ward (e.g., because a ward setting specifies conditions for automatically recognizing wards). As shown in the figure, a real-time FOV may be identified for a guardian and each ward.

In accordance with a threat identification algorithm, command module 230 may first perform a vulnerability assessment. For example, a ward who is closer to the edge of a sidewalk may be determined to be more vulnerable than a ward who is further away from the street. As another example, the more wards there are, the more vulnerable command module 230 may determine such wards to be (e.g., because there is a high risk for disorderly conduct, a tendency toward slower movement as group size increases). As yet another example, the higher the pedestrian density the more vulnerable command module 230 may determine any wards to be (e.g., because it may be harder to keep wards together). Similarly, the further the ward is from a guardian or the slower the pace of a ward, the more vulnerable command module 230 may determine any such ward to be. In a similar manner, vulnerability assessments may also be made for a guardian (e.g., too close to the street, too far from wards, keeping too slow a pace, not paying proper attention to wards). In some embodiments, if command module 230 determines that one or more measures of vulnerability within the vulnerability assessment fail to satisfy vulnerability limits (e.g., by failing to stay below safety thresholds), command module 230 may generate a tracker notification indicating who is deemed too vulnerable (e.g., a guardian, one or more wards), a corrective action (e.g., step away from the sidewalk), any directional information that may aid a guardian or ward to perform the corrective action (e.g., “stay with the group on your left John”), etc. In addition, where events suddenly increase a vulnerability measure above an acceptable threshold, a tracker notification may be used by command module 230 to correct the situation. For example, a ward who has become separated from a guardian by a cyclist or vehicle may result in a tracker notification being given as described herein (e.g., “Look behind you Alice. A cyclist just blocked the crosswalk and Sally is stranded.”).

In some embodiments, a measure of threat to a guardian, ward, or both may be adjusted by any relevant vulnerability assessment. For example, a speeding vehicle may be adjusted to be a higher threat for a ward that is closer to the edge of a sidewalk as opposed to a ward further from the road. As another example, a ward that is behind a vehicle barrier or parked car may have a vulnerability measure that reduces the measure of a threat.

For example, as shown in FIG. 4, a guardian 420 may be travelling with ward 410, ward 430, and ward 440. If a vehicle is travelling within a blind spot caused by vehicle 460, command module 230 may assess that ward 410 is more vulnerable than ward 430 or ward 440. As another example, if ward 430 and ward 440 are falling behind, command module 230 may determine they have a heightened vulnerability. In some embodiments, command module 230 may determine whether guardian 420 or the associated wards are likely to cross in time (e.g., relative to a pedestrian countdown timer) and provide a tracker notification if any member of the group is likely to cross in excess of a threshold (e.g., when the pedestrian countdown timer reaches zero).

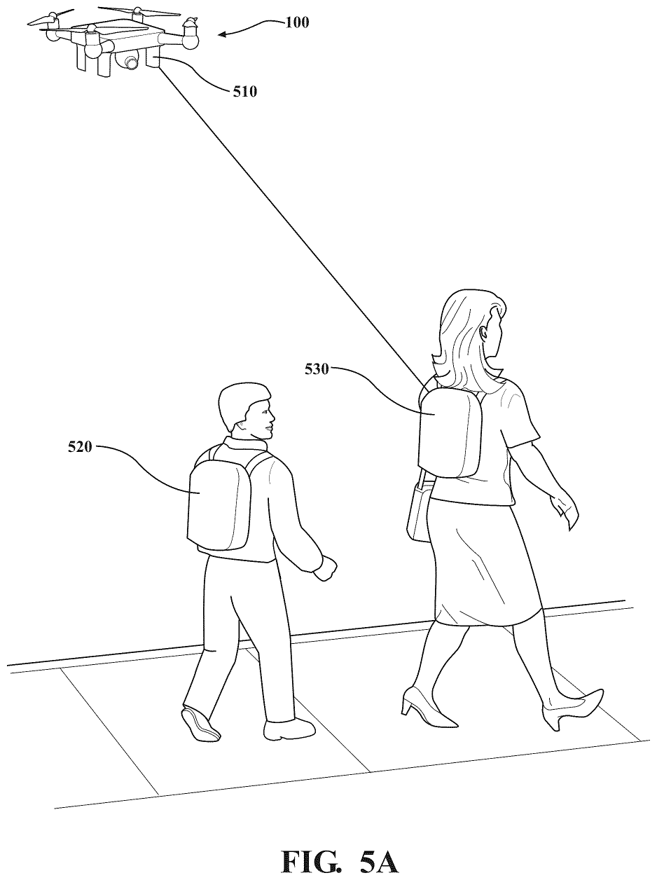

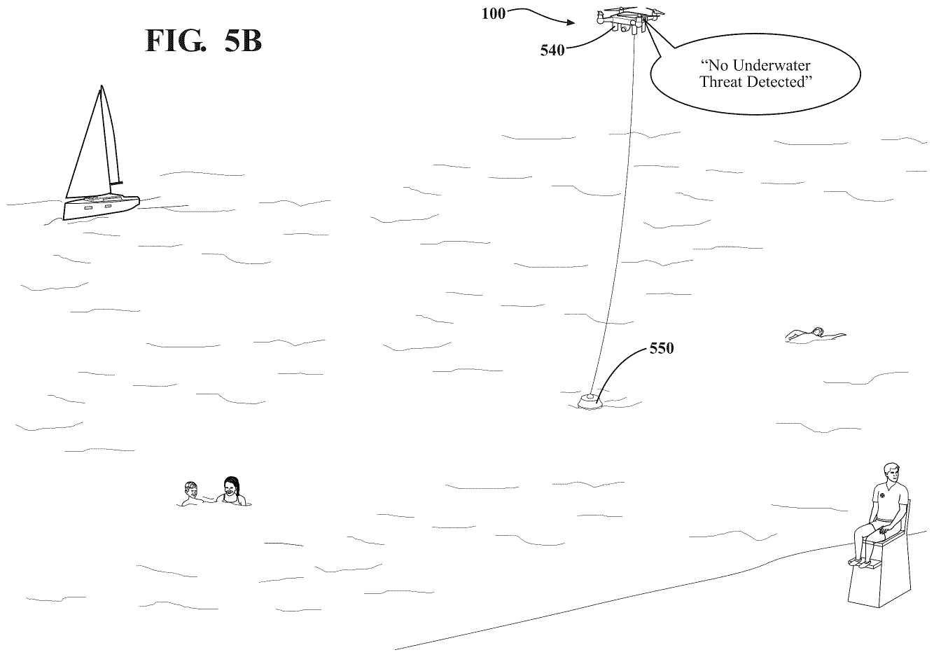

In some embodiments, drone 100 may utilize a tether system. For example, as shown in FIG. 5A, drone 100 may be comprised of a flying drone component 510 that is tethered to a base station, such as backpack 530. In this manner, flying drone component 510 may obtain power without the necessity of carrying larger batteries. As another example, as shown in FIG. 5B, drone 100 may be comprised of a flying drone component 540 that is tethered to water drone component 550. In this manner, flying drone component 540 may look for issues above water that may be difficult for water drone component 550 to detect and vice versa. While the tether system as shown in FIGS. 5A and 5B may be advantageous, it is not necessarily a required component in such examples. For example, instead of a tether arrangement flying drone components 510 or 540 may instead take advantage of swappable batteries that may be exchanged as needed, such as by mechanically or magnetically exchanging batteries with a base station (e.g., backpack 530, water drone component 550).

As another example, drone 100 may be a flying drone component associated with a police vehicle. The police officer may be a guardian, while people detained at a traffic stop may automatically be identified as wards by command module 230. Based on real-time FOV, command module 230 may warn such a guardian or ward of threats they may not be aware of, such as a drunk driver about to hit the rear of the police car at high speed, using the methods and systems described herein. In some embodiments, ward settings may also be used to generate tracker notifications, such as if a ward engages in prohibited behavior that may place a guardian, a ward, or both at risk.

In some embodiments, the systems and methods described herein may be provided for one or more users without regard to a guardian or ward status. In such an embodiment, a user may utilize any functionality of a ward or guardian as described herein. In some embodiments, the systems and methods described herein may support one or more guardians, even when no wards are present (e.g., because the crossing guard is waiting for children to arrive). In some embodiments, the systems and methods described herein may support one or more wards, even when no guardians are present (e.g., because a drone is configured to travel with a child even if a guardian is not present). In some embodiments, the systems and methods described herein may support multiple guardians overseeing multiple wards.

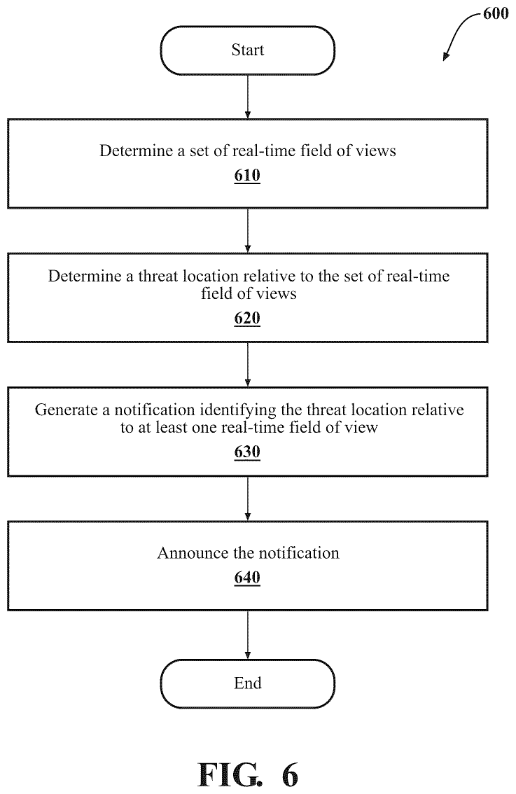

FIG. 6 illustrates a flowchart of a method 600 that is associated with strategies for providing increased situational awareness through guardian drones. Method 600 will be discussed from the perspective of the drone management system 170 of FIGS. 1 and 2. While method 600 is discussed in combination with the drone management system 170, it should be appreciated that the method 600 is not limited to being implemented within drone management system 170 but is instead one example of a system that may implement method 600.

At step 610, command module 230 may determine a set of real-time field of views. For example, a drone flying overhead may capture images of a guardian and wards from above, while vehicles and non-vehicular devices provide ground level of images. Based on a combination of information from such images, command module 230 may determine a set of real-time field of views for each guardian and ward. For example, an overhead image may indicate the length and wdith of a hedge next to a guardian, while a ground image indicates the height of the hedge, thereby allowing command module 230 to determine whether the guardian can see over the hedge or alternatively the extent to which the guardians field of view is restricted.

At step 620, command module 230 may determine a threat location relative to the set of real-time field of views. For example, command module 230 may generate a coverage map that is used to evaluate for the possibility of threats by a drone.

At step 630, command module 230 may generate a notification identifying the threat location relative to at least one real-time field of view. For example, once a threat is identified, command module 230 may determine the position of the threat relative to a guardian's real-time field of view (e.g., behind the guardian). In addition, command module 230 may also determine the position of the target of the threat relative to a real-time field of view (e.g., the guardian's real-time field of view).

At step 640, command module 230 may announce the notification. For example, command module 230 may announce through visual, auditory, or haptic devices the location of a threat or target relative to a guardian.

FIG. 1 will now be discussed in full detail as an example environment within which the system and methods disclosed herein may operate. In some instances, drone 100 is configured to switch selectively between various modes, such as an autonomous mode, one or more semi-autonomous operational modes, a manual mode, etc. Such switching may be implemented in a suitable manner, now known, or later developed. “Manual mode” means that all of or a majority of the navigation/maneuvering of the drone is performed according to inputs received from a user (e.g., remote operator).

In one or more embodiments, drone 100 is an autonomous drone. As used herein, “autonomous drone” refers to a drone that operates in an autonomous mode. “Autonomous mode” refers to using one or more computing systems to control drone 100, such as providing navigation/maneuvering of drone 100 along a travel route, with minimal or no input from a human driver. In one or more embodiments, drone 100 is either highly automated or completely automated. In one embodiment, drone 100 is configured with one or more semi-autonomous operational modes in which one or more computing systems perform a portion of the navigation/maneuvering of the drone along a travel route, and a drone operator (i.e., remote operator) provides inputs to the drone to perform a portion of the navigation/maneuvering of drone 100 along a travel route.

Drone 100 may include one or more processors 110. In one or more arrangements, processor(s) 110 may be a main processor of drone 100. For instance, processor(s) 110 may be an electronic control unit (ECU). Drone 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

In one or more arrangements, data store(s) 115 may include map data 116. Map data 116 may include maps of one or more geographic areas. In some instances, map data 116 may include information or data on roads, traffic control devices, road markings, structures, features, landmarks, or any combination thereof in the one or more geographic areas. Map data 116 may be in any suitable form. In some instances, map data 116 may include aerial views of an area. In some instances, map data 116 may include ground views of an area, including 360-degree ground views. Map data 116 may include measurements, dimensions, distances, information, or any combination thereof for one or more items included in map data 116. Map data 116 may also include measurements, dimensions, distances, information, or any combination thereof relative to other items included in map data 116. Map data 116 may include a digital map with information about road geometry. Map data 116 may be high quality, highly detailed, or both.

In one or more arrangements, map data 116 may include one or more terrain maps 117. Terrain map(s) 117 may include information about the ground, terrain, roads, surfaces, other features, or any combination thereof of one or more geographic areas. Terrain map(s) 117 may include elevation data in the one or more geographic areas. Terrain map(s) 117 may be high quality, highly detailed, or both. Terrain map(s) 117 may define one or more ground surfaces, which may include paved roads, unpaved roads, land, and other things that define a ground surface.

In one or more arrangements, map data 116 may include one or more static obstacle maps 118. Static obstacle map(s) 118 may include information about one or more static obstacles located within one or more geographic areas. A “static obstacle” is a physical object whose position does not change or substantially change over a period of time and whose size does not change or substantially change over a period of time. Examples of static obstacles include trees, buildings, curbs, fences, railings, medians, utility poles, statues, monuments, signs, benches, furniture, mailboxes, large rocks, hills. The static obstacles may be objects that extend above ground level. The one or more static obstacles included in static obstacle map(s) 118 may have location data, size data, dimension data, material data, other data, or any combination thereof, associated with it. Static obstacle map(s) 118 may include measurements, dimensions, distances, information, or any combination thereof for one or more static obstacles. Static obstacle map(s) 118 may be high quality, highly detailed, or both. Static obstacle map(s) 118 may be updated to reflect changes within a mapped area.

Data store(s) 115 may include sensor data 119. In this context, “sensor data” means any information about the sensors that drone 100 is equipped with, including the capabilities and other information about such sensors. As will be explained below, drone 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of map data 116 or sensor data 119 may be located in data stores(s) 115 located onboard drone 100. Alternatively, or in addition, at least a portion of map data 116 or sensor data 119 may be located in data stores(s) 115 that are located remotely from drone 100.

As noted above, drone 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of drone 100 (including any of the elements shown in FIG. 1), or any combination thereof. Sensor system 120 may acquire data of at least a portion of the external environment of drone 100 (e.g., nearby vehicles).

Sensor system 120 may include any suitable type of sensor. Various examples of different types of sensors will be described herein. However, it will be understood that the embodiments are not limited to the particular sensors described. Sensor system 120 may include one or more vehicle sensors 121. Vehicle sensor(s) 121 may detect, determine, sense, or acquire in a combination thereof information about drone 100 itself. In one or more arrangements, vehicle sensor(s) 121 may be configured to detect, sense, or acquire in a combination thereof position and orientation changes of drone 100, such as, for example, based on inertial acceleration. In one or more arrangements, vehicle sensor(s) 121 may include one or more accelerometers, one or more gyroscopes, an inertial measurement unit (IMU), a dead-reckoning system, a global navigation satellite system (GNSS), a global positioning system (GPS), a navigation system 147, other suitable sensors, or any combination thereof. Vehicle sensor(s) 121 may be configured to detect, sense, or acquire in a combination thereof one or more characteristics of drone 100. In one or more arrangements, vehicle sensor(s) 121 may include a speedometer to determine a current speed of drone 100.

Alternatively, or in addition, sensor system 120 may include one or more environment sensors 122 configured to acquire, sense, or acquire in a combination thereof driving environment data. “Driving environment data” includes data or information about the external environment in which an autonomous drone is located or one or more portions thereof. For example, environment sensor(s) 122 may be configured to detect, quantify, sense, or acquire in any combination thereof obstacles in at least a portion of the external environment of drone 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of drone 100, such as, for example, lane markers, signs, traffic lights, traffic signs, lane lines, crosswalks, curbs proximate to drone 100, off-road objects, etc.

Various examples of sensors of sensor system 120 will be described herein. The example sensors may be part of the one or more environment sensor(s) 122, the one or more vehicle sensors 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more cameras 126, or any combination thereof. In one or more arrangements, camera(s) 126 may be high dynamic range (HDR) cameras or infrared (IR) cameras.

Drone 100 may include an input system 130. An “input system” includes any device, component, system, element or arrangement or groups thereof that enable information/data to be entered into a machine. Input system 130 may receive an input from a remote operator (e.g., via a smart phone or tablet). Drone 100 may include an output system 135. An “output system” includes any device, component, or arrangement or groups thereof that enable information/data to be presented to a a Guardian or other people, animals, etc.

Drone 100 may include one or more vehicle systems 140. Various examples of vehicle system(s) 140 are shown in FIG. 1. However, drone 100 may include more, fewer, or different vehicle systems. It should be appreciated that although particular vehicle systems are separately defined, each or any of the systems or portions thereof may be otherwise combined or segregated via hardware, software, or a combination thereof within drone 100. Drone 100 may include a propulsion system 141, a braking system 142, a steering system 143, throttle system 144, a transmission system 145, a signaling system 146, a navigation system 147, other systems, or any combination thereof. Each of these systems may include one or more devices, components, or combinations thereof, now known or later developed.

Navigation system 147 may include one or more devices, applications, or combinations thereof, now known or later developed, configured to determine the geographic location of the drone 100, to determine a travel route for drone 100, or to determine both. Navigation system 147 may include one or more mapping applications to determine a travel route for drone 100. Navigation system 147 may include a global positioning system, a local positioning system, a geolocation system, or any combination thereof.

Processor(s) 110, drone management system 170, automated driving module(s) 160, or any combination thereof may be operatively connected to communicate with various aspects of vehicle system(s) 140 or individual components thereof. For example, returning to FIG. 1, processor(s) 110, automated driving module(s) 160, or a combination thereof may be in communication to send or receive information from various aspects of vehicle system(s) 140 to control the movement, speed, maneuvering, heading, direction, etc. of drone 100. Processor(s) 110, drone management system 170, automated driving module(s) 160, or any combination thereof may control some or all of these vehicle system(s) 140 and, thus, may be partially or fully autonomous.

Processor(s) 110, drone management system 170, automated driving module(s) 160, or any combination thereof may be operable to control at least one of the navigation or maneuvering of drone 100 by controlling one or more of vehicle systems 140 or components thereof. For instance, when operating in an autonomous mode, processor(s) 110, drone management system 170, automated driving module(s) 160, or any combination thereof may control the direction, speed, or both of drone 100. Processor(s) 110, drone management system 170, automated driving module(s) 160, or any combination thereof may cause drone 100 to accelerate (e.g., by increasing the supply of fuel provided to the engine), decelerate (e.g., by decreasing the supply of fuel to the engine, by applying brakes), change direction (e.g., by turning the front two wheels), or perform any combination thereof. As used herein, “cause” or “causing” means to make, force, compel, direct, command, instruct, enable, or in any combination thereof an event or action to occur or at least be in a state where such event or action may occur, either in a direct or indirect manner.

Drone 100 may include one or more actuators 150. Actuator(s) 150 may be any element or combination of elements operable to modify, adjust, alter, or in any combination thereof one or more of vehicle systems 140 or components thereof to responsive to receiving signals or other inputs from processor(s) 110, automated driving module(s) 160, or a combination thereof. Any suitable actuator may be used. For instance, actuator(s) 150 may include motors, pneumatic actuators, hydraulic pistons, relays, solenoids, and piezoelectric actuators, just to name a few possibilities.

Drone 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Drone 100 may include one or more autonomous driving module(s) 160. Automated driving module(s) 160 may be configured to receive data from sensor system 120 or any other type of system capable of capturing information relating to drone 100, the external environment of the drone 100, or a combination thereof. In one or more arrangements, automated driving module(s) 160 may use such data to generate one or more driving scene models. Automated driving module(s) 160 may determine position and velocity of drone 100. Automated driving module(s) 160 may determine the location of obstacles, obstacles, or other environmental features including traffic signs, trees, shrubs, neighboring vehicles, pedestrians, etc.

Automated driving module(s) 160 may be configured to receive, determine, or in a combination thereof location information for obstacles within the external environment of drone 100, which may be used by processor(s) 110, one or more of the modules described herein, or any combination thereof to estimate: a position or orientation of drone 100; a drone position or orientation in global coordinates based on signals from a plurality of satellites or other geolocation systems; or any other data/signals that could be used to determine a position or orientation of drone 100 with respect to its environment for use in either creating a map or determining the position of drone 100 in respect to map data.

Automated driving module(s) 160 either independently or in combination with drone management system 170 may be configured to determine travel path(s), current autonomous driving maneuvers for drone 100, future autonomous driving maneuvers, modifications to current autonomous driving maneuvers, etc. Such determinations by automated driving module(s) 160 may be based on data acquired by sensor system 120, driving scene models, data from any other suitable source such as determinations from sensor data 250, or any combination thereof. In general, automated driving module(s) 160 may function to implement different levels of automation, including advanced driving assistance (ADAS) functions, semi-autonomous functions, and fully autonomous functions. “Driving maneuver” means one or more actions that affect the movement of a drone. Examples of driving maneuvers include accelerating, decelerating, braking, turning, moving in a lateral direction of drone 100, changing travel lanes, merging into a travel lane, and reversing, just to name a few possibilities. Automated driving module(s) 160 may be configured to implement driving maneuvers. Automated driving module(s) 160 may cause, directly or indirectly, such autonomous driving maneuvers to be implemented. As used herein, “cause” or “causing” means to make, command, instruct, enable, or in any combination thereof an event or action to occur or at least be in a state where such event or action may occur, either in a direct or indirect manner. Automated driving module(s) 160 may be configured to execute various drone functions, whether individually or in combination, to transmit data to, receive data from, interact with, or to control drone 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory communicably coupled to the processor and storing machine-readable instructions that, when executed by the processor, cause the processor to:
determine a set of real-time field of views;
determine a threat location relative to the set of real-time field of views;
generate a notification identifying the threat location relative to at least one real-time field of view; and
announce the notification.

2. The system of claim 1, wherein the machine-readable instruction to determine the set of real-time field of views is based on sensor data received from multiple vehicles.

3. The system of claim 1, wherein the machine-readable instruction to determine the set of real-time field of views is based on sensor data received from a vehicle and a non-vehicular system.

4. The system of claim 1, wherein the machine-readable instruction to determine the set of real-time field of views is based on head movements of a person and head movements of an animal.

5. The system of claim 1, wherein the machine-readable instruction to generate the notification identifying the threat location also includes identifying a target location relative to the at least one real-time field of view.

6. The system of claim 5, wherein the machine-readable instruction to announce the notification provides the threat location and the target location relative to the at least one real-time field of view.

7. The system of claim 1, wherein the machine-readable instruction to announce the notification is provided via a directional alert message relative to the at least one real-time field of view.

8. A non-transitory computer-readable medium including instructions that when executed by one or more processors cause the one or more processors to:
determine a set of real-time field of views;
determine a threat location relative to the set of real-time field of views;
generate a notification identifying the threat location relative to at least one real-time field of view; and
announce the notification.

9. The non-transitory computer-readable medium of claim 8, wherein the instruction to determine the set of real-time field of views is based on sensor data received from multiple vehicles.

10. The non-transitory computer-readable medium of claim 8, wherein the instruction to determine the set of real-time field of views is based on sensor data received from a vehicle and a non-vehicular system.

11. The non-transitory computer-readable medium of claim 8, wherein the instruction to determine the set of real-time field of views is based on head movements of a person and head movements of an animal.

12. The non-transitory computer-readable medium of claim 8, wherein the instruction to generate the notification identifying the threat location also includes identifying a target location relative to the at least one real-time field of view.

13. The non-transitory computer-readable medium of claim 12, wherein the instruction to announce the notification provides the threat location and the target location relative to the at least one real-time field of view.

14. A method, comprising:
determining a set of real-time field of views;
determining a threat location relative to the set of real-time field of views;
generating a notification identifying the threat location relative to at least one real-time field of view; and
announcing the notification.

15. The method of claim 14, wherein determining the set of real-time field of views is based on sensor data received from multiple vehicles.

16. The method of claim 14, wherein determining the set of real-time field of views is based on sensor data received from a vehicle and a non-vehicular system.

17. The method of claim 14, wherein determining the set of real-time field of views is based on head movements of a person and head movements of an animal.

18. The method of claim 14, wherein generating the notification identifying the threat location also includes identifying a target location relative to the at least one real-time field of view.

19. The method of claim 18, wherein announcing the notification provides the threat location and the target location relative to the at least one real-time field of view.

20. The method of claim 14, wherein announcing the notification is provided via a directional alert message relative to the at least one real-time field of view.
